(19) United States
(12) Patent Application Publication
(10) Pub. No.: US 2025/0219549 A1
(43) Pub. Date: Jul. 3, 2025

(54) TRANSFORMER COUPLED MODULAR MULTILEVEL CONVERTER AS RECTIFIER FOR HYDROGEN ELECTROLYSER

(71) Applicant: Hitachi Energy Ltd, Zürich (CH)

(72) Inventors: Jan SVENSSON, Västerås (SE); Philippe MAIBACH, Muhen (CH); Jean-Philippe HASLER, Västerås (SE); Gunnar INGESTRÖM, Västerås (SE); Michail VASILADIOTIS, Zurich (CH)

(21) Appl. No.: 18/851,969

(22) PCT Filed: Mar. 28, 2022
(86) PCT No.: PCT/EP2022/058159

§ 371 Date: Sep. 27, 2024

(51) Int. Cl. H02M 7/219; C25B 9/65; C25B 9/70; C25B 15/02; H01F 38/14

(52) U.S. Cl. CPC H02M 7/219; C25B 9/65; C25B 9/70; C25B 15/02; H01F 38/14

(57) ABSTRACT

A system comprises at least one transformer for galvanically isolating the system from an electrical power grid and adapting an input voltage level associated with an alternating current received from the electrical power grid. A converter unit connected to the transformer is configured to convert the alternating current into a direct current output between a positive pole and a negative pole. The converter unit comprises at least one modular multilevel converter comprising at least two converter branches. Each branch comprises a converter cell and an inductor. One branch is connected from an AC line of the transformer to the positive pole and another branch is connected from the AC line to the negative pole. An electrolyser unit may be arranged between the positive and negative poles, and a control unit may be configured to control the direct current output based on a reference value.

### TECHNICAL FIELD

The present disclosure generally relates to the field of electrical power conversion and, in particular, to a method and system for hydrogen electrolyser rectifier in electrolyser stations. More specifically, the present disclosure relates to a system including a converter arrangement for converting an AC current into a DC current for use with an electrolyser unit and to a method for controlling such a system.

### BACKGROUND

In order to limit the impact and the negative effects of climate change, a reduction of emission of CO₂ and other gases which contribute to global warming is needed. One way to de-carbonize sectors which are hard to reach with other methods is by using hydrogen, which is an energy carrier. One way of producing hydrogen is by electrolysis, which splits water into oxygen and hydrogen using electricity. By using electricity from renewable sources, so called “green hydrogen” can be produced.

Hydrogen may for example be produced to a large extent when there is an excess of renewable power, such as wind or solar, and the electricity prices are low. There are several electrolyser technologies that can be used in order to produce hydrogen. Regardless of the chemical reaction used in the process, the systems normally include at least one power electronic converter transforming an AC current from the electrical power grid to a DC current.

One example used today for conversion is the 12-pulse thyristor rectifier. This solution is however problematic and brings challenges, for example since harmonics on the AC side will vary with varying electrolyser load. There is therefore a need for harmonic filters to be used together with the thyristor rectifiers. A further issue with the use of thyristor rectifiers is that the reactive power varies with the produced hydrogen, which needs to be solved by the use of a STATCOM.

It is therefore of interest to provide an improved method and system for transforming the AC current to a DC current for use with an electrolyser unit.

### SUMMARY

It is therefore a goal of the present disclosure to provide a system and a method which may provide a controlled power conversion for use with an electrolyser unit.

To achieve this goal, the present disclosure provides a system comprising at least one transformer, a converter unit, an electrolyser unit, a control unit, and a method for controlling the system, as defined by the independent claims. Further embodiments are provided in the dependent claims.

According to a first aspect of the present disclosure, a system is provided. The system comprises at least one transformer connectable to an electrical power grid. The at least one transformer is configured for galvanically isolating the system from the electrical power grid and for adapting an input voltage level associated with an alternating current received from the electrical power grid. The system further comprises a converter unit connected to the at least one transformer. The converter unit is configured to convert the received alternating current into a direct current output between a positive pole and a negative pole of the converter unit. The converter unit comprises at least one modular multilevel converter. The at least one modular multilevel converter comprises converter branches. A converter branch is connected from an AC line of the at least one transformer to the positive pole (of the converter unit) and another converter branch is connected from the AC line of the at least one transformer to the negative pole (of the converter unit). Each converter branch comprises at least one converter cell and at least one inductor. The system further comprises an electrolyser unit arranged between the positive pole and the negative pole of the converter unit. The system further comprises a control unit configured to control the direct current output from the converter unit to the electrolyser unit based on a reference value for driving the electrolyser unit.

According to a second aspect of the present disclosure, a method for controlling a system is provided. The system comprises at least one transformer connectable to an electrical power grid for galvanically isolating the system from the electrical power grid and for adapting an input voltage level of an alternating current received from the electrical power grid. The system further comprises a converter unit connected to the at least one transformer and configured to convert the received alternating current into a direct current output between a positive pole and a negative pole of the converter unit. The converter unit comprises at least one modular multilevel converter comprising converter branches. A converter branch is connected from an AC line of the at least one transformer to the positive pole and another converter branch is connected from the AC line of the at least one transformer to the negative pole. Each converter branch comprises at least one converter cell and at least one inductor. The system further comprises an electrolyser unit arranged between the positive pole and the negative pole.

The method comprises receiving a reference value for driving the electrolyser unit and indicative of a target value for either the direct current output between the positive pole and the negative pole of the converter unit or for a voltage drop across the positive pole and the negative pole of the converter unit. The method further comprises receiving information indicative of a real current value of the direct current output or a real voltage value of the voltage drop. The real current value may be determined either based on a measurement of the direct current output or based on a measurement of the received alternating current followed by an estimation of the direct current output based on the measured received alternating current. The real voltage value may be determined based on a voltage measurement representative of a voltage across the positive and the negative pole of the converter unit. The method further comprises controlling the converter cells of the at least one modular multilevel converter of the converter unit based on the received information and the received reference value.

By reference value it is herein meant a control value to be used for operating the electrolyser unit. A reference value may for example be the volume or amount of hydrogen to be produced by the electrolyser unit or the rate at which the electrolyser unit is intended to produce hydrogen. Such a reference value may then be indicative or at least representative of a target value to be used for operation of the converter unit in order to achieve the reference value. The target value derived from the reference value may for example be the level of direct current to be output between the positive and negative poles of the converter unit or the voltage level between the positive and negative poles of the converter unit. The target value derived from the reference value may also be both the level of direct current output between the poles and the voltage level between the poles.

It will be appreciated that a converter branch may be referred to as a converter arm, where a modular multilevel converter includes upper arms/branches and lower arms/branches. Each phase usually includes an upper arm and a lower arm, wherein the upper arm is connected to the positive pole of the converter unit and the lower arm is connecter to the negative pole of the converter unit.

The positive and negative poles of the converter unit may also be referred to as the positive and negative terminals of the converter unit.

Thus, there are provided a system and a method with a first function to convert, with at least one modular multilevel converter, an alternating current received from an electrical power grid to a direct current output to an electrolyser unit. The amount of hydrogen produced via electrolysis is expected to increase within the next few years. Thus, having more reliable systems and methods for providing power to electrolysers are very advantageous. The present system provides advantages over other systems since the use of a modular multilevel converter in the converter unit does not pollute the electrical power grid with harmonics, or at least significantly reduces the occurrence of harmonics on the AC side. Further, compared to prior art systems based on the use of a thyristor rectifier, the need of harmonic filters on the AC side is reduced, and possible even suppressed. Further, the system and method provide the possibility of controlling reactive power in the electrical power grid. The fast regulation of the reactive power together with the system's possibility to control the active power to the electrolyser can be used to stabilize a grid with a high degree of renewables. Thusly, the need of added passive or active reactive power compensation may be reduced, and possibly even suppressed.

Further, since the grid code, i.e. requirements on connected devices of the electrical power grid, can be fulfilled with the present system, the need of STATCOMs usually connected to a point of common connection between the system, a renewable power plant and the electrical power grid is reduced or even vanished.

Further, the system provides low harmonic content of voltage and current on the DC side, which is beneficial for operation of the electrolyser unit. The high flexibility of the system is further beneficial to handle and adapt the DC voltage or the DC current of the electrolyser unit over time since electrolyser units may degrade over their lifetime. Further, the present system and method may also be used to support island grids. The electrolyser unit may require a high rated current and, in the future, the rated current will probably increase even more when the electrolyser units are further developed. The modularity of the system provides a solution that may be used for future electrolyser units requiring a higher rated current than today's electrolysers.

According to an embodiment, the converter unit includes a first number Z of modular multilevel converters which are coupled in a parallel circuit. The first number Z is larger than 1. The present embodiment is advantageous in that the flexibility of the system is increased. By coupling a plurality of modular multilevel converters in parallel, the rated current to the electrolyser unit can be increased. This can be advantageous since different electrolyser units may require differently rated currents, thereby ensuring that the system may be used for any electrolyser unit. Each of the modular multilevel converters may contribute to an equal part of the current to be provided to the electrolyser unit. For example, in case Z equals 2, each modular multilevel converter may provide 50% of the required current to the electrolyser unit. It is however understood that this is only an example and the contribution of each of the modular multilevel converters may vary depending on the characteristics (such as the number of converter cells and rated current) of the modular multilevel converters and the method for controlling the system, or even the condition of the individual modular multilevel converters. The first number Z can be any number larger than 1. However, as disclosed within the present disclosure, a system with only one modular multilevel converter is plausible.

According to an embodiment, the at least one transformer includes a second number W of transformers. In other words, the system may comprise a number W of transformers. This second number W may be equal to the first number Z such that each transformer is connected to one modular multilevel converter. The present embodiment is advantageous in that each modular multilevel converter is connected to one transformer. The transformers are used both to adapt the incoming voltage to the modular multilevel converters and to galvanically isolate the modular multilevel converters. By providing a transformer for each modular multilevel converter, the flexibility of the system is increased, and the modular multilevel converters are individually isolated. Further, the present system may be advantageous for handling very high alternating current from the electrical power grid.

According to an embodiment, the at least one transformer is a single transformer connected to the first number Z of modular multilevel converters. The present embodiment is advantageous in that providing one transformer is a cheaper alternative. Depending on the number of modular multilevel converters, one transformer may be sufficient for the system. The transformer may be any type of transformer. The transformer may for example be a two-winding transformer. A two-winding transformer includes one three-phase connection on the grid side and one three-phase connection on the converter side. The transformer may also be a three-winding transformer. A three-winding transformer includes one three-phase connection on the grid side and two three-phase connections on the side of the converters. A system using only one transformer may be advantageous for lower alternating current from the electrical power grid.

According to an embodiment, the at least one transformer includes a second number W of transformers and the second number W is less than the first number Z. At least one of the second number W of transformers may be connected to a plurality of modular multilevel converters. In the present embodiment one transformer may be coupled to a plurality of modular multilevel converters or to a single modular multilevel converter, thereby increasing the flexibility of the system. The transformers may be any kind of transformer. The transformers may be two-winding transformers. The transformers may also be three-winding transformers. The transformers may also include both two-winding and three-winding transformers.

According to an embodiment, the at least one modular multilevel converter comprises six converter branches. The six converter branches include three branches each connected from an AC line of the at least one transformer to the positive pole and another three branches each connected from a respective AC line of the at least one transformer to the negative pole of the converter unit. In other words, the present embodiment provides a system for a three-phase AC side.

According to an embodiment, each converter branch includes a plurality of serially-connected converter cells (or converter cells connected in series). It will be appreciated that, in case some of the serially-connected converter cells are not needed, or in case one or more converter cells stop functioning for any reason, these cells may be by-passed without disengaging or stopping the system.

According to an embodiment, the at least one inductor is arranged between the AC line and the plurality of serially-connected converter cells or between the serially-connected converter cells and the positive or negative pole. The inductor may also be referred to as a branch reactor and may be any type of branch reactor.

According to an embodiment, each converter branch includes a plurality of inductors. At least one of the plurality of inductors is arranged between two converter cells of the plurality of serially-connected converter cells. The present embodiment is advantageous in case of internal ground faults. The inductors may be any type of branch reactor.

According to an embodiment, each converter cell of the at least one converter cell of each converter branch has a full-bridge topology. In other words, the at least one modular multilevel converter may be based on full-bride converter cells. The full-bridge converter cells may include any self-commutated semiconductor switches. These self-commutated semiconductor switches include at least insulated-gate bipolar transistors (IGBTs), integrated gate-commutated thyristors (IGCTs), injection-enhanced gate transistors (IEGTs), gate turn-off thyristors (GTOs), and metal-oxide-semiconductor field-effect transistors (MOSFETs).

According to an embodiment, each converter branch includes at least one converter cell with full-bridge topology and at least one converter cell with half-bridge topology. Since the voltage applied to the electrolyser units, i.e. the voltage drop between the positive pole and the negative pole of the converter unit, should be positive, the modular multilevel converters may use a mixture of full-bridge converter cells and half-bridge converter cells. The present embodiment is advantageous in that half-bridge converter cells may be cheaper to manufacture than full-bridge converter cells.

According to an embodiment, the control unit is configured to control the direct current output to the electrolyser unit by comparing a real current value to a target current value or by comparing a real voltage value to a target voltage value. The target current value and the target voltage value are derived from the reference value. The real current value is determined either based on a measurement of the direct current output or based on a measurement of the received alternating current followed by an estimation of the direct current output based on the measured received alternating current. The real voltage value is determined based on a voltage measurement representative of a voltage across the positive pole and the negative pole of the converter unit. The present embodiment is an example of how the control unit may control the system, and in particular the converter cells of the at least one modular multilevel converter unit. Depending on the requirements of the electrolyser unit, the direct current output may vary. The control unit may therefore control the modular multilevel converters such that the combined output current from the modular multilevel converters matches the current required for operation of the electrolyser unit. The control unit may also be configured to control the system based on a measurement representative of a voltage between the positive pole and the negative pole. Such a measurement may for example be the voltage between the poles, or it may correspond to a combined value of voltages measured over electrolyser stacks of the electrolyser unit or a combined value of voltages measured at each converter cell. Further, the control unit may be configured to change from a voltage control to a current control as soon as an electric current starts flowing through the electrolyser unit, or at least as soon as an electric current above a certain threshold starts flowing through the electrolyser unit.

According to an embodiment, the system further comprises at least one end inductor arranged between one of the converter branches and the positive pole or the negative pole. In the present embodiment, at least one end inductor, or a branch reactor, is added after the at least one modular multilevel converter. In case the system has a plurality of modular multilevel converters, there may be a plurality of end inductors. The end inductors may for example be placed between the positive pole and a terminal of each modular multilevel converter connected to the positive pole. The end inductors may also be placed between the negative pole and a terminal of each modular multilevel converter connected to the negative pole. The system may further comprise, for each modular multilevel converter, one end inductor coupled between the positive pole and the modular multilevel converter and one end inductor coupled between the negative and the modular multilevel converter. The present embodiment provides current sharing, limits the harmonics and reduces the impact of faults.

According to an embodiment, the electrolyser unit comprises a plurality of serially connected electrolyser stacks. The electrolyser unit may include electrolyser stacks of any type. The electrolyser stacks may in turn include a plurality of electrolyser cells connected in series. The electrolyser stacks and cells may for example be based on alkaline, proton exchange membrane (PEM) or solid oxide technologies. Advantages of an alkaline electrolyser unit are, compared to other types of electrolyser units, that they comprise cheaper catalysts, and have a higher lifespan. Advantages of a PEM electrolyser unit, compared to other electrolysers, are that they have a higher current density, are more compact, have a smaller footprint, have a faster response, and allow for a more dynamic operation.

According to an embodiment, the system further comprises an electrolyser protection unit. The electrolyser protection unit is configured to limit the current through the electrolyser unit based on information indicative of individual maximum voltages of the electrolyser stacks and a maximum voltage limit and/or configured to cause bypassing of malfunctioning electrolyser stacks. The electrolyser stacks, and the possible plurality of electrolyser cells in each stack, may have different characteristics due to, for example, aging degradation, temperature differences, and manufacturing processes. The electrolyser protection unit may ensure that the voltage over an individual electrolyser stack does not exceed a maximum value for that individual electrolyser stack. The electrolyser protection unit may further cause bypassing of malfunctioning electrolyser stacks, or electrolyser cells of the electrolyser stacks.

According to an embodiment, the at least one converter cell comprises a mechanical by-pass switch configured to by-pass the converter cell. The present embodiment is advantageous in case a converter cell is malfunctioning.

According to an embodiment, the system may optionally comprise at least one of at least one filter and a surge arrestor arranged between the positive pole and a ground connection or between the negative pole and a ground connection. The at least one filter may comprise at least one resistor and at least one capacitor or at least one power electronic device configured to filter harmonics. The present embodiment is advantageous in that the RC-filter or a filter comprising a power electronic device can reduce, and possibly remove, any harmonics created on the DC side. It is further envisioned that the system may comprise more than one filter. For example, there may be one filter coupled between the negative pole and the ground connection and one between the positive pole and the ground connection. Further, there may be a filter coupled between each modular multilevel converter and the ground connection. A surge arrestor may be advantageous since it limits overvoltages.

According to an embodiment, the reference value is indicative of at least one of an amount of hydrogen to be produced by the electrolyser unit, a current to be conducted through the electrolyser unit, a voltage to be applied over the electrolyser unit, and a condition of the electrolyser unit. The reference value may be any relevant information received from the electrolyser unit indicative of a voltage or current needed to drive the electrolyser unit.

According to an embodiment, controlling the converter cells includes transitioning from a voltage control mode to a current control mode when the direct current output has reached a predetermined threshold.

The received information may therefore change from being indicative of the real voltage value to the real current value when transitioning from the voltage control mode to the current control mode.

With a voltage control mode is meant a control mode in which the control unit is configured to control the converter cells such that a specific voltage is applied between the positive and negative poles of the converter unit. With a current control mode is meant a control mode in which the control unit is configured to control the converter cells such that a specific DC current is output between the positive and negative poles of the converter unit.

The control unit may be configured to transition between these two modes, for example when the direct current output reaches a predetermined threshold after start-up of the system.

According to an embodiment, the converter unit includes a number Y of functioning modular multilevel converters. Controlling the converter cells may include increasing a current provided by remaining functioning modular multilevel converters if the number Y decreases. For example, the system may keep working even if one or more modular multilevel converters experiences a fault or are malfunctioning. The modularity of the system allows the control unit to control the remaining functioning modular multilevel converters in order to deliver the required direct current output to the electrolyser unit assuming that the remaining functioning modular multilevel converters can handle the increased current.

According to another embodiment, still with a converter unit including a number Y of functioning modular multilevel converter, controlling the converter cells includes adjusting the reference value if the number Y decreases. For example, in case the modular multilevel converters are already functioning at a maximum load, the reference value may be adjusted if one or more of the modular multilevel converters are malfunctioning. This may ensure that the system keeps delivering a direct current output to the electrolyser unit.

Other objectives, features and advantages of the disclosed embodiments will be apparent from the following detailed disclosure as well as from the drawings.

It is noted that embodiments of the present disclosure relate to all possible combinations of features recited in the claims. Further, it will be appreciated that the various embodiments described for the system as defined in accordance with the first aspect and the embodiments described for the method according to the second aspect are all combinable with each other.

### BRIEF DESCRIPTION OF THE DRAWINGS

This and other aspects of the present disclosure will now be described in more detail, with reference to the appended drawings showing embodiment(s) of the disclosure.

FIGS. 1a and 1b schematically show systems according to exemplifying embodiments of the present disclosure.

FIGS. 2a and 2b schematically show exemplifying converter cells that may be used in a system according to an exemplifying embodiment of the present disclosure.

FIGS. 3-11c schematically show systems according to exemplifying embodiments of the present disclosure.

FIG. 12 shows a schematic graph of the voltage over the electrolyser unit as a function of the current at the electrolyser unit.

FIG. 13 shows a flowchart of a method according to an exemplifying embodiment of the present disclosure.

### DETAILED DESCRIPTION

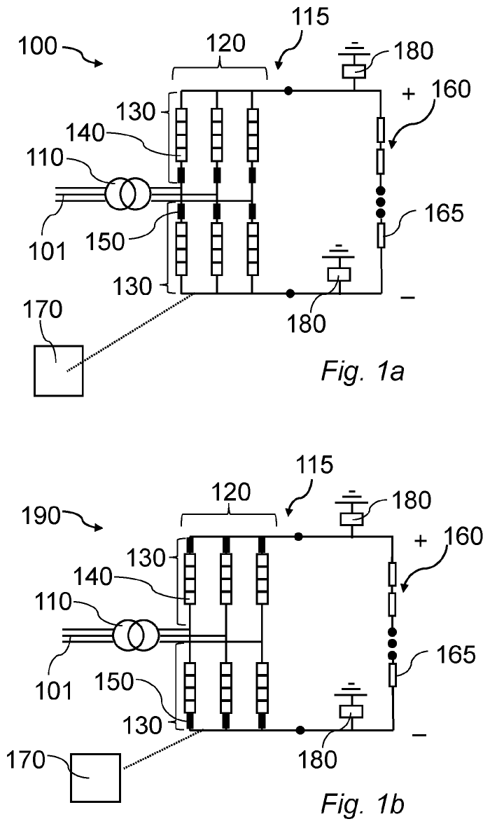

FIG. 1a schematically shows a system 100 according to an exemplifying embodiment of the present disclosure.

The system 100 comprises a transformer 110 connectable to an electrical power grid 101 for galvanically isolating the system 100 from the electrical power grid 101 and for adapting an input voltage level associated with an alternating current received from the electrical power grid 101. The electrical power grid 101 may be understood as being part of a local, regional, national, or international electrical power grid, to which the system 100 is connected. The electrical power grid 101 may for example deliver an excess power created by renewable energy sources such as wind or solar power for saving the excess energy as hydrogen for later use. The electrical power grid 101 in the current embodiment has three connection lines for three phases. It is also conceivable that the system 100 is used in other applications with an electrical power grid 101 with less, or more phases.

The system 100 further comprises a converter unit 115 connected to the transformer 110 and configured to convert the alternating current received from the electrical power grid 101 into a direct current which is output between a positive pole and a negative pole of the converter unit 115. The converter unit 115 in the embodiment disclosed in FIG. 1a comprises one modular multilevel converter 120. The modular multilevel converter 120 may be realized as a double star AC/DC converter. The modular multilevel converter 120 comprises six branches 130. Each converter branch comprises four converter cells 140 and one inductor 150. The inductor 150 may be any type of branch reactor. The six converter branches 130 include three converter branches 130 connected from the AC lines of the transformer 110 to the positive pole. The six converter branches 130 also include three converter branches 130 connected from the AC lines of the transformer 110 to the negative pole. There are thusly two converter branches 130 for each phase of the electrical power grid 101. Further, the system 100 comprises an electrolyser unit 160 arranged between the positive pole and the negative pole of the converter unit 115. The system 100 also comprises a control unit 170 configured to control the converter cells 140 of the converter unit 115 such that a certain direct current is output from the converter unit 115 to the electrolyser unit 160.

In the present embodiment the converter unit 115 comprises one modular multilevel converter 120. It is however envisaged that the converter unit 115 may comprise more than one modular multilevel converter, such as for example a first number Z of modular multilevel converters coupled in a parallel circuit. The first number Z may then be larger than 1. Depending on the rated current required for operation of the electrolyser unit 160, a different number of modular multilevel converters 120 may be used. Expressed differently, in general, the converter unit 115 may include a plurality of modular multilevel converter 120 electrically connected in parallel.

In FIG. 1a, the modular multilevel converter 120 comprises six converter branches (or arms) 130 for a three-phase system. However, depending on the intended application and the need of either one, two or three-phases for example, it will be appreciated that the modular multilevel converter 120 may comprise another number of converter branches 130. For instance, in case the electrical power grid 101 would only provide one phase, the modular multilevel converter may include only four converter branches 130. In other words, in general, the modular multilevel converter 120 may include at least four converter branches 130.

Further, as for example illustrated in the system shown in FIG. 1a, the modular multilevel converters 120 may comprise a number of phase-legs, wherein a phase-leg includes one converter branch 130 coupled from the AC-line to the positive pole and one converter branch 130 coupled from the same AC-line to the negative pole. The system 100 illustrated in FIG. 1a includes a modular multilevel converter 120 with three phase-legs, one for each phase of the electrical power grid 101.

Each converter branch 130 in FIG. 1a comprises four serially-connected converter cells 140. This is however only for illustration purposes and the converter branches 130 may include a different number of converter cells 140 ranging from 1 to an arbitrary integer number N. With a plurality of converter cells 140, the modular multilevel converters 120 can deliver a higher direct current to the electrolyser unit 160. Each converter cell 140 may comprise a mechanical by-pass switch configured to by-pass the converter cell 140. In case one converter cell 140 is damaged or malfunctioning, the converter cell 140 may be by-passed and the remaining converter cells 140 may be configured to provide a higher voltage to compensate for the by-passed converter cell 140.

The converter cells 140 may have a full-bridge topology. The converter cells 140 may also include converter cells 140 with a full-bridge topology and converter cells 140 with a half-bridge topology.

The electrolyser unit 160 may comprise a plurality of serially-connected electrolyser stacks 165. The electrolyser stacks 165 may be connected in series between the positive pole and the negative pole of the converter unit. The electrolyser stacks 165 may each include a plurality of electrolyser cells. The electrolyser stacks and cells 165 may be of any hydrogen electrolyser type. The electrolyser stacks 165 may for example be based on alkaline, PEM, or solid oxide technologies.

In FIG. 1a, the inductor 150 of each converter branch 130 is placed between the AC line and the converter cells 140 of each converter branch 130. It is however plausible to have other placements for the inductors 150, as for example described in connection to FIG. 1b.

The embodiment in FIG. 1a further comprises two filters 180. The filters 180 may include at least one resistor and at least one capacitor, the filters 180 may be any suitable RC-filters. The filters 180 may also comprise at least one power electronic device configured to filter harmonics. The filters 180 may also be a combination of an RC-filter and power electronic devices. In general, the filters 180 may be one of, or a combination of, a passive filter and an active filter. One filter 180 is arranged between the positive pole of the converter unit 115 and a ground connection. The other filter 180 is arranged between the negative pole of the converter unit 115 and a ground connection. The filters 180 may reduce the presence of harmonics in the system 100, and in particular on the DC side. Additionally, the system 100 may also include a surge arrestor arranged between one or both of the poles and the ground. A surge arrestor may be advantageous since it may limit overvoltages.

FIG. 1b schematically shows a system 100 according to an exemplifying embodiment of the present disclosure.

The system 190 of FIG. 1b is similar to the system 100 disclosed in FIG. 1a except that the inductors 150 are arranged between the converter cells 140 and the positive and negative pole of the converter unit. Hence, FIGS. 1a and 1b illustrate to alternative embodiments, wherein the inductor may be connected either at the AC side of a branch or at the DC side of a branch. The system 190 in FIG. 1b could have more or less than four converter cells 140 in each converter branch 130. It is further understood that the system 190 in FIG. 1b could have more than one inductor 150 in each converter branch 130.

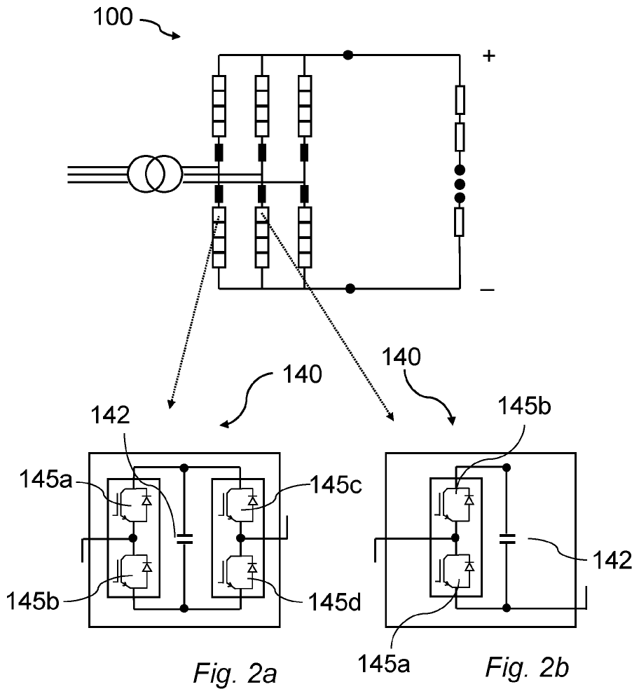

FIGS. 2a and 2b schematically show exemplifying converter cells 140 that may be used in a system 100 according to an exemplifying embodiment of the present disclosure.

In certain embodiment of the present disclosure, each converter cell 140 of the systems 100 and 190 has a full-bridge topology. A converter cell 140 with full-bridge topology is illustrated in FIG. 2a. The converter cell 140 in FIG. 2a comprises first to fourth semiconductor switches 145a, 145b, 145c, 145d that are connected in a full-bridge configuration. The converter cell 140 further comprises an energy storage which is typically implemented as a capacitor arrangement comprising at least one capacitor 142. The capacitor is configured to store electrical energy and thereby provide a voltage. The semiconductor switches 145a, 145b, 145c, 145d may include any self-commutated semiconductor switches. These self-commutated semiconductor switches include at least IGBT, IGCT, IEGT, GTO, MOSFET.

In certain embodiments of the present disclosure, each converter branch 130 may include at least one converter cell 140 with full-bridge topology and at least one converter cell 140 with half-bridge topology. A converter cell 140 with half-bridge topology is illustrated in FIG. 2b. The converter cell 140 comprises first and second semiconductor switches 145a, 145b connected in a half-bridge configuration. The converter cell 140 further comprises an energy storage which is typically implemented as a capacitor arrangement comprising at least one capacitor 142. The capacitor is configured to store electrical energy and thereby provide a voltage. The semiconductor switches 145a, 145b, may include any self-commutated semiconductor switches. These self-commutated semiconductor switches include at least IGBT, IGCT, IEGT, GTO, MOSFET.

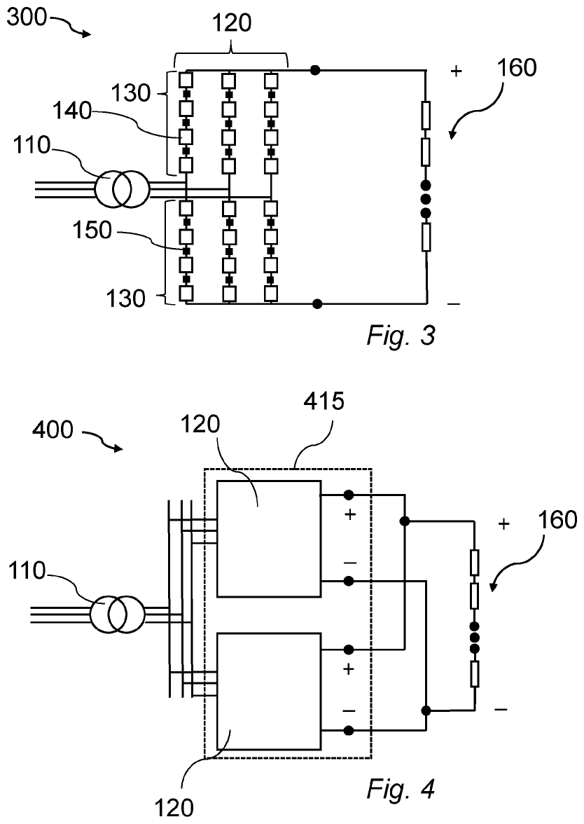

FIG. 3 schematically shows a system 300 according to an exemplifying embodiment of the present disclosure.

The system 300 disclosed in FIG. 3 is similar to the previously disclosed systems and may include any features discussed with regards to the previous

Figures. In the system 300 shown in FIG. 3, each converter branch 130 includes a plurality of inductors 150 and at least one of the plurality of inductors 150 is arranged between two converter cells 140 of the plurality of serially-connected converter cells 140. In FIG. 3, each of the inductors 150 is placed between two, consecutively arranged, converter cells 140 in the converter branches 130. Such an arrangement of the inductors 150 provide an improved handling of internal ground faults. It may also be envisaged a system with inductors 150 placed between only some of the converter cells 140. It is further plausible to also have inductors placed between the AC line and the converter cells 140 or between the converter cells and the positive or negative pole, such as shown in FIGS. 1a and 1b. A combination of these different placements for the inductors 150 is also plausible.

FIG. 4 schematically shows a system 400 according to an exemplifying embodiment of the present disclosure.

The converter unit 415 in the system 400 shown in FIG. 4 comprises two modular multilevel converters 120 which are coupled in a parallel circuit (i.e. in parallel on the DC side). Each modular multilevel converter 120 may include any of the features disclosed above in relation to the previous Figures. Coupling two modular multilevel converters 120 in a parallel circuit allows for a higher current to be provided to the electrolyser unit 160. Each modular multilevel converter 120 may for example be configured to provide 50% of the current required by the electrolyser unit 160. However, other configurations are possible. One modular multilevel converter 120 may for example be configured to provide a larger current than the other. The modular multilevel converters 120 may be similar in every aspect or may differ from one another. For example, one of the modular multilevel converters may include branches with more serially-connected converter cells than the other modular multilevel converter.

The modular multilevel converters 120 shown in FIG. 4 are coupled to the same two-winding transformer 110. It is however possible that each of the modular multilevel converters 120 is connected to the electrical power grid 101 by its own two-winding transformer 110. Further, it is possible to have a three-winding transformer coupling the modular multilevel converters 120 to the electrical power grid 101. The converter unit 415 may also include more than two modular multilevel converters 120. In general, the converter unit 415 may include a first number Z of modular multilevel converters 120 which are coupled in a parallel circuit.

The system 400 further comprises a control unit 170 configured to control the direct current output from the converter unit 415. The control unit 170 may be configured to control each modular multilevel converter individually 120. Hence, if a fault is located in one of the modular multilevel converters 120, the control unit may cause the faulty modular multilevel converter to be decoupled while the load on the remaining modular multilevel converters 120 is increased.

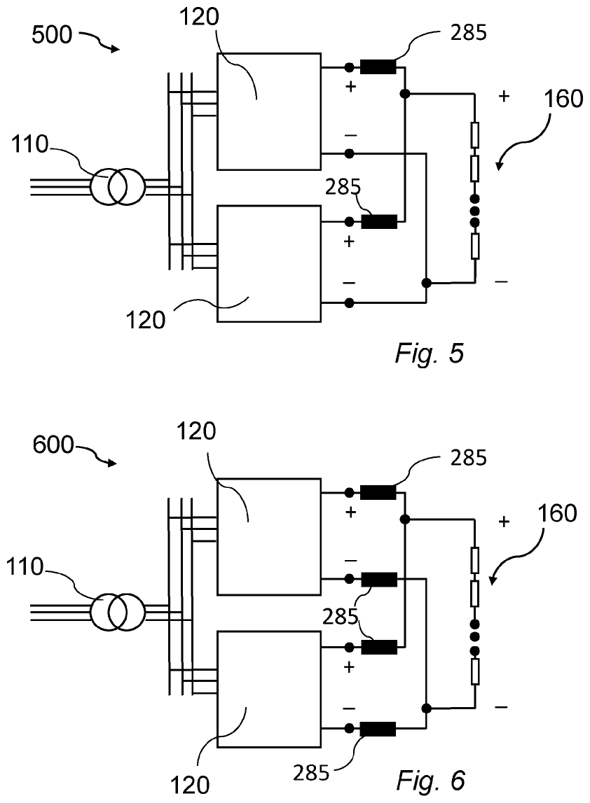

FIG. 5 schematically shows a system 500 according to an exemplifying embodiment of the present disclosure.

The system 500 illustrated in FIG. 5 is similar to the system disclosed above with reference to e.g. FIG. 4. However, the system 500 in FIG. 5 further comprises two end inductors 285. Each end inductor 285 is placed between one of the modular multilevel converters 120 and the positive pole of the converter unit. The end inductors 285 may handle the current sharing between the modular multilevel converters 120. The end inductors 285 may further limit the harmonics and reduce the impact of possible faults.

FIG. 6 schematically shows a system 600 according to an exemplifying embodiment of the present disclosure.

The system 600 in FIG. 6 is similar to the system 500 described with reference to FIG. 5 except that the system 600 in FIG. 6 comprises four end inductors 285. The two additional end inductors 285 are in the present system 600 placed between the modular multilevel converters 120 and the negative pole of the converter unit.

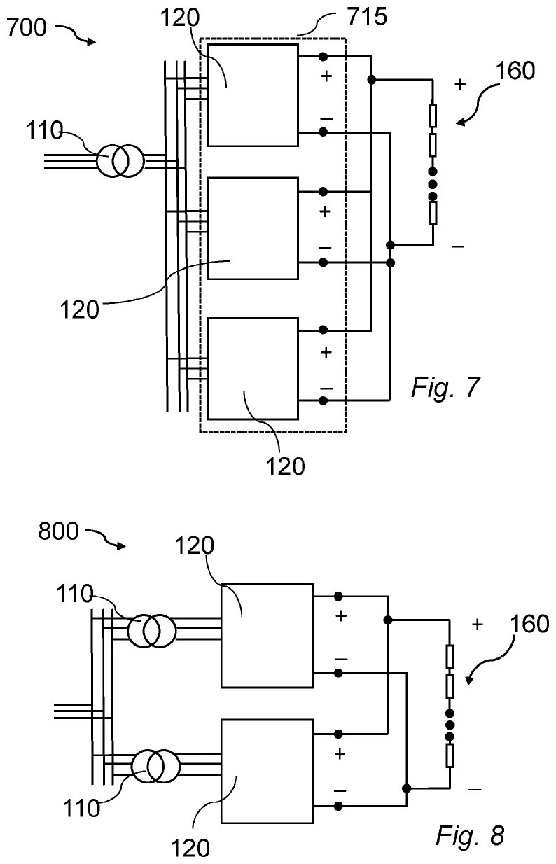

FIG. 7 schematically shows a system 700 according to an exemplifying embodiment of the present disclosure.

The converter unit 715 in FIG. 7 comprises three modular multilevel converters 120 which are coupled in a parallel circuit, i.e. the positive terminals of each one of the modular multilevel converters are connected together to a common positive pole of the converter unit while the negative terminals of the each one of the modular multilevel converters are connected together to a common negative pole of the converter unit. The modular multilevel converters 120 may have any of the features discussed above with respect to the embodiments illustrated in the preceding figures.

FIG. 8 schematically shows a system 800 according to an exemplifying embodiment of the present disclosure.

The system 800 illustrated in FIG. 8 is equivalent to the system 400 described with reference to FIG. 4 except that the system 800 comprises two transformers 110. Each transformer 110 is coupled to one modular multilevel converter 120. Such a system 800 may be beneficial for handling very high powers.

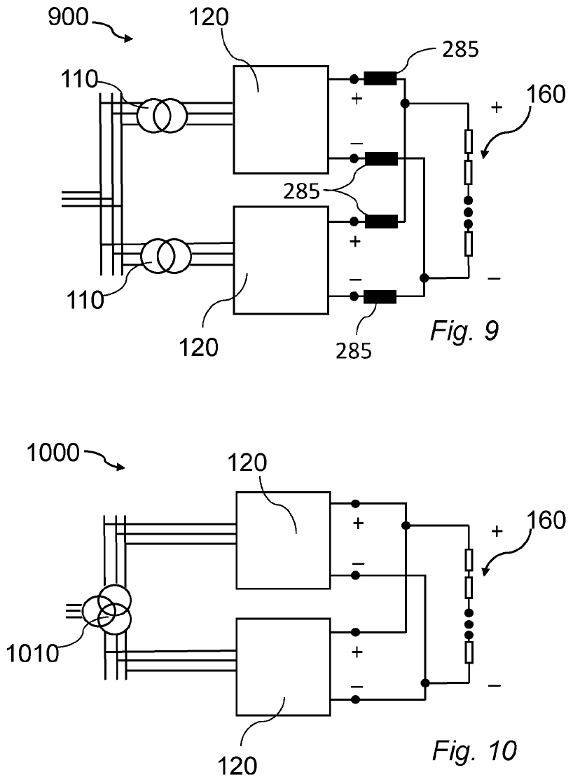

FIG. 9 schematically shows a system 900 according to an exemplifying embodiment of the present disclosure.

The system 900 in FIG. 9 is equivalent to the system 800 illustrated in FIG. 8 except that it comprises four end inductors 285 arranged between the modular multilevel converters and the poles of the converter unit 115, such as illustrated in FIG. 6. Expressed differently, the system 900 is arranged in a similar manner as the system 800 of FIG. 8 on the AC side while it is arranged in a similar manner as the system 600 of FIG. 6 on the DC side.

FIG. 10 schematically shows a system 1000 according to an exemplifying embodiment of the present disclosure.

The system 1000 disclosed in FIG. 10 is similar to the system 400 described with reference to FIG. 4 except that, instead of a two-winding transformer 110, the system 1000 of FIG. 10 includes a three-winding transformer 1010. The three-winding transformer 1010 is configured to galvanically isolate the system 1000 and to adapt the input voltage level associated with the alternating current received from the electrical power grid.

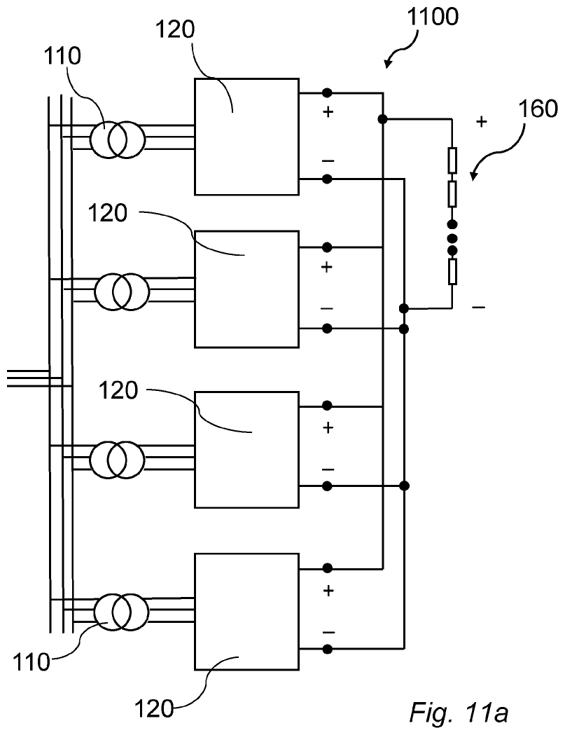

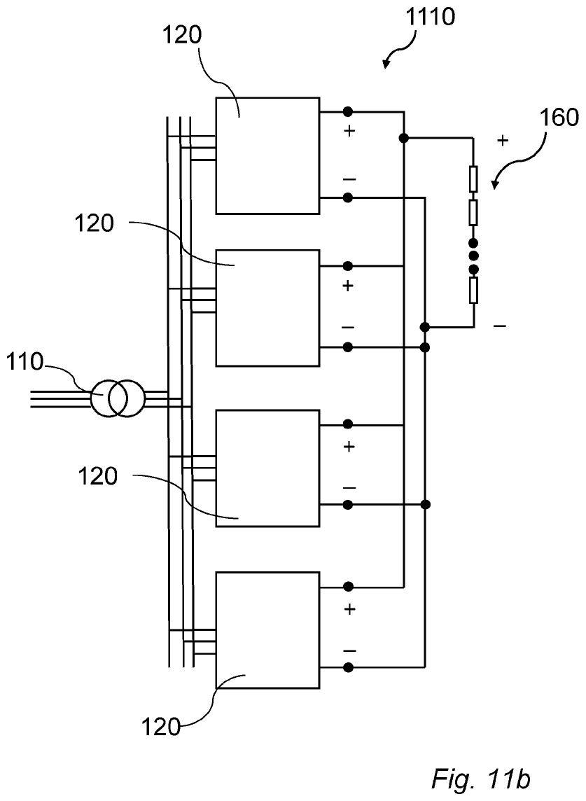

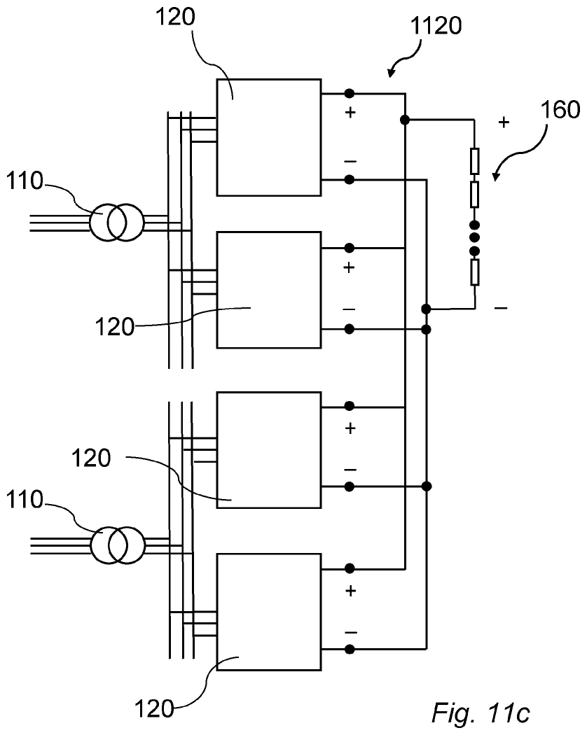

FIGS. 11a-11c schematically show systems 100 according to further exemplifying embodiments of the present disclosure.

The systems 1100, 1110 and 1120 illustrated in FIGS. 11a-11c all include converter units comprising four modular multilevel converters 120. The difference between the systems 1100, 1110 and 1120 is the number of transformers 110. The system 1100 in FIG. 11a comprises four transformers 110, wherein each transformer 110 is coupled to one modular multilevel converter 120. The system 1110 in FIG. 11b comprises one single transformer 110, wherein the transformer 110 is connected to the four modular multilevel converters 120. The system 1120 in FIG. 11c comprises two transformers 110, wherein each transformer 110 is connected to two modular multilevel converters 120. The modular multilevel converters may therefore be grouped so that they share a transformer on the AC side.

These examples illustrate that the converter unit may include a first number Z of modular multilevel converters 120 which are coupled in a parallel circuit. The system may then further include a second number W of transformers 110 for galvanically isolating the system 100 and adapting the input voltage level associated with the received alternating current from the electrical power grid. The second number W may be the same as the first number Z, as shown in FIG. 11a, but it may also be lower than the first number Z, as shown in FIGS. 11b and 11c. The transformers 110 may be coupled to one or a plurality of modular multilevel converters 120. In other words, in the present examples, the system includes Z modular multilevel converters 120 and W transformers 110.

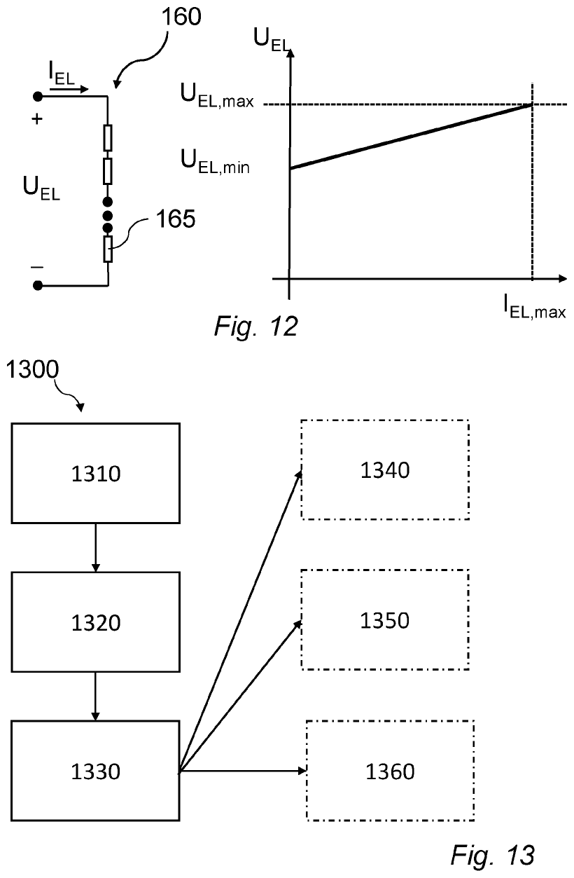

FIG. 12 shows a schematic graph illustrating the voltage over the electrolyser unit 160 as a function of the current at the electrolyser unit 160.

The electrolyser unit 160 may comprise a plurality of serially connected electrolyser stacks 165. An electrolyser stack 165 may comprise a plurality of serially connected electrolyser cells. The electrolyser unit 160 is arranged between the positive pole and the negative pole of the converter unit. The direct current output from the converter unit to the electrolyser unit 160 may be denoted IEL. This current flows through the electrolyser unit 160 and contributes to the electrolysis for the production of hydrogen. The voltage drop from the positive pole to the negative pole, i.e. the voltage across the electrolyser unit 160, may be denoted UEL. As can be seen in FIG. 12, the current IEL increases if the voltage UEL increases (and vice versa).

The control unit of the system may be configured to control the converter unit (and more specifically the switches of the converter cells of the modular multilevel converters) based on a reference value at which the electrolyser unit is to be operated. This reference value may for example be an amount of hydrogen to be produced by the electrolyser unit (e.g. during a certain time). Such a reference value may in turn be indicative of a target value for the voltage UEL and/or the current IEL to be used for operation of the electrolyser unit 160, which corresponds to the voltage drop across the positive and negative poles of the converter unit and the current provided by the converter unit between the positive and negative poles.

The control unit may therefore be configured to control the system to reach this target value. This may be performed based on received information indicative of a voltage value or a current value. Since no current IEL will run through the electrolyser unit 160 at start, the control unit may first control the system in a voltage control mode until the absolute value of the current reaches a certain threshold and then change to a current control mode.

The system may further include an electrolyser protection unit. The electrolyser protection unit may be configured to protect the electrolyser unit. The electrolyser unit may be configured to limit the current through the electrolyser unit based on information indicative of individual maximum voltages of the electrolyser stacks 165 and a maximum voltage limit for the electrolyser unit. The electrolyser stacks 165 required to drive the electrolyser stacks may vary depending on aging degradation, temperature difference, manufacturing process and more. This may also mean that the electrolyser stacks may each have a maximum voltage it can handle without breaking. The electrolyser protection unit may therefore be configured to limit the current through the electrolyser unit based on these individual voltages. The electrolyser protection unit may further be configured to cause a bypass switch to bypass malfunctioning electrolyser stacks, or to bypass malfunctioning electrolyser cells within the electrolyser stacks.

FIG. 13 shows a flowchart of a method 1300 according to an exemplifying embodiment of the present disclosure.

The method 1300 may be implemented in a control unit and configured for controlling a system according any exemplifying embodiment of the present disclosure, such as those shown in FIGS. 1-11.

The method 1300 comprises receiving 1310 a reference value for driving the electrolyser unit. As mentioned above, the reference value may be indicative of a target value for the direct current output or for a voltage drop across the positive pole and the negative pole of the converter unit or for both the direct current output and the voltage drop. The reference value may be a voltage value or a current value. The reference value may alternatively be an amount of hydrogen to be created by the electrolyser unit. The reference value may be any reference value related to the electrolyser unit that may be indicative of a voltage or current for operating the electrolyser unit.

The method 1300 further comprises receiving information 1320 indicative of a real current value of the direct current output or of a real voltage value of the voltage drop. The real current value may be determined based on a measurement of the direct current output. The real current value may also be determined based on a measurement of the received alternating current followed by an estimation of the direct current output based on the measured received alternating current. The real voltage value may be determined based on a voltage measurement representative of a voltage across the positive and the negative poles of the converter unit. The measurement representative of a voltage across the positive and the negative poles of the converter unit may be obtained by measurement of a voltage across the positive and negative poles of the converter unit. The measurement representative of the voltage across the positive and the negative poles of the converter unit may also be a combined voltage from (e.g. the sum of) individual voltage measurements over each electrolyser stack of the electrolyser unit. The measurement representative of the voltage across the positive and negative poles of the converter unit may also be obtained by from individual voltage measurements over each modular multilevel converter or each converter cell in each converter branch of each modular multilevel converter.

The method 1300 further comprises the step of controlling 1330 the converter cells of the at least one modular multilevel converter of the converter unit based on the received information and the received reference value. In case the received reference value is indicative of a target value for the direct current output, the controlling 1330 of the cells of the modular multilevel converters may control the direct current output from the modular multilevel converters. In case the received reference value is a current value, then the controlling 1330 may be performed in order for the system to match the direct current output with the current value.

The method 1300 may in certain embodiments include more steps. Controlling 1330 the converter cells may include transitioning 1340 from a voltage control mode to a current control mode when the direct current output has reached a predetermined threshold. The received information may then change from being indicative of the real voltage value to the real current value when transitioning 1340 from the voltage control mode to the current control mode. It may be beneficial to control the system in a voltage control mode when starting the system since until the voltage drop over the poles of the converter units reaches a certain value, in principle no current will flow through the electrolyser unit.

The converter unit of the system may include a number Y of functioning modular multilevel converters. The step of controlling 1330 the converter cells may include increasing 1350 a current through the remaining functioning modular multilevel converters if the number Y decreases. In case one or more of the modular multilevel converters are malfunctioning, the load on the remaining modular multilevel converters may be increased. By allowing the load to be increased on the functioning modular multilevel converters, the direct output current to the electrolyser unit may remain unchanged, thereby improving stability of the system.

The step of controlling 1330 may also include changing 1360 the reference value if the number Y decreases. In case the load on the modular multilevel converters is already at a maximum and one or more of the modular multilevel converters are malfunctioning, the load cannot be increased on the remaining modular multilevel converters. By instead changing the reference value, the control unit can still control the system. However, the direct current output delivered to the electrolyser unit may be decreased in such a scenario.

While the present invention has been illustrated in the appended drawings and the foregoing description, such illustration is to be considered illustrative or exemplifying and not restrictive; the present invention is not limited to the disclosed embodiments. Other variations to the disclosed embodiments can be understood and effected by those skilled in the art in practicing the claimed invention, from a study of the drawings, the disclosure, and the appended claims. In the appended claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A system comprising:
at least one transformer connectable to an electrical power grid for galvanically isolating the system from the electrical power grid and for adapting an input voltage level associated with an alternating current (AC) received from the electrical power grid;
a converter unit connected to the at least one transformer and configured to convert the received alternating current into a direct current output between a positive pole and a negative pole of the converter unit, wherein the converter unit comprises at least one modular multilevel converter comprising converter branches, wherein a converter branch is connected from an AC line of the at least one transformer to the positive pole and another converter branch is connected from the AC line of the at least one transformer to the negative pole, and wherein a converter branch comprises at least one converter cell and at least one inductor;
an electrolyser unit arranged between the positive pole and the negative pole of the converter unit; and
a control unit configured to control the direct current output from the converter unit to the electrolyser unit based on a reference value for driving the electrolyser unit,
wherein the control unit is configured to control the direct current output to the electrolyser unit by comparing a real current value to a target current value or by comparing a real voltage value to a target voltage value, wherein the target current value and the target voltage value are derived from the reference value, wherein the real current value is either determined based on a measurement of the direct current output or based on a measurement of the received alternating current followed by an estimation of the direct current output based on the measured received alternating current, and wherein the real voltage value is determined based on a voltage measurement representative of a voltage across the positive pole and the negative pole of the converter unit, and
wherein the control unit is configured to transition from a voltage control mode to a current control mode when the direct current output has reached a predetermined threshold.

2. The system according to claim 1, wherein the converter unit includes a first number Z of modular multilevel converters which are coupled in a parallel circuit, wherein the first number Z is larger than 1.

3. The system according to claim 2, wherein the at least one transformer includes a second number W of transformers, wherein the second number W is equal to the first number Z, and wherein each transformer is connected to one modular multilevel converter.

4. The system according to claim 2, wherein the at least one transformer is a single transformer connected to the first number Z of modular multilevel converters.

5. The system according to claim 2, wherein the at least one transformer includes a second number W of transformers, wherein the second number W is less than the first number Z, and wherein at least one of the second number W of transformers is connected to a plurality of modular multilevel converters.

6. The system according to claim 1, wherein the at least one modular multilevel converter comprises six converter branches, wherein the six converter branches include three branches each connected from an AC line of the at least one transformer to the positive pole and another three branches each connected from a respective AC line of the at least one transformer to the negative pole of the converter unit.

7. The system according to claim 1, wherein each converter branch includes a plurality of serially-connected converter cells.

8. The system according to claim 7, wherein the at least one inductor is arranged between the AC line and the plurality of serially-connected converter cells or between the serially-connected converter cells and the positive or negative pole.

9. The system according to claim 7, wherein each converter branch includes a plurality of inductors, and wherein at least one of the plurality of inductors is arranged between two converter cells of the plurality of serially-connected converter cells.

10. The system according to claim 1, wherein each converter cell of the at least one converter cell of each converter branch has a full-bridge topology.

11. The system according to claim 1, wherein each converter branch includes at least one converter cell with full-bridge topology and at least one converter cell with half-bridge topology.

12. The system according to claim 1, further comprising at least one end inductor arranged between one of the converter branches and the positive pole or the negative pole.

13. The system according to claim 1, wherein the electrolyser unit comprises a plurality of serially-connected electrolyser stacks.

14. The system according to claim 13, further comprising an electrolyser protection unit, wherein the electrolyser protection unit is configured to limit the current through the electrolyser unit based on information indicative of individual maximum voltages of the electrolyser stacks and a maximum voltage limit and/or wherein the electrolyser protection unit is configured to cause bypassing of a malfunctioning electrolyser stack.

15. The system according to claim 1, wherein the at least one converter cell comprises a mechanical by-pass switch configured to by-pass the converter cell.

16. The system according to claim 1, further comprising at least one of at least one filter and a surge arrestor arranged between the positive pole and a ground connection or between the negative pole and a ground connection, wherein the at least one filter comprises at least one resistor and at least one capacitor or at least one power electronic device configured to filter harmonics.

17. The system according to claim 1, wherein the reference value is indicative of at least one of an amount of hydrogen to be produced by the electrolyser unit, a current to be conducted through the electrolyser unit, a voltage applied to the electrolyser unit, or a condition of the electrolyser unit.

18. A method for controlling a system comprising at least one transformer connectable to an electrical power grid for galvanically isolating the system from the electrical power grid and for adapting an input voltage level of an alternating current (AC) received from the electrical power grid, a converter unit connected to the at least one transformer and configured to convert the received alternating current into a direct current output between a positive pole and a negative pole of the converter unit, wherein the converter unit comprises at least one modular multilevel converter comprising converter branches, wherein a converter branch is connected from an AC line of the at least one transformer to the positive pole and another converter branch is connected from the AC line of the at least one transformer to the negative pole, and wherein each converter branch comprises at least one converter cell and at least one inductor, and wherein the system further comprises an electrolyser unit arranged between the positive pole and the negative pole of the converter unit, the method comprising:
receiving a reference value for driving the electrolyser unit and indicative of a target value for either the direct current output between the positive pole and the negative pole of the converter unit or for a voltage drop across the positive pole and the negative pole of the converter unit;
receiving information indicative of a real current value of the direct current output or of a real voltage value of the voltage drop, wherein the real current value is either determined based on a measurement of the direct current output or based on a measurement of the received alternating current followed by an estimation of the direct current output based on the measured received alternating current, and wherein the real voltage value is determined based on a voltage measurement representative of a voltage across the positive and the negative pole of the converter unit; and
controlling the direct current output to the electrolyser unit from the converter cells of the at least one modular multilevel converter of the converter unit based on the received information and the received reference value by comparing the real current value to a target current value or by comparing the real voltage value to a target voltage value, wherein the target current value and the target voltage value are derived from the reference value,
wherein controlling the converter cells includes transitioning from a voltage control mode to a current control mode when the direct current output has reached a predetermined threshold.

19. The method according to claim 18, wherein the converter unit includes a number Y of functioning modular multilevel converters, and wherein controlling the converter cells includes increasing a current provided by remaining functioning modular multilevel converters if the number Y decreases.

20. The method according to claim 18, wherein the converter unit includes a number Y of functioning modular multilevel converters, and wherein controlling the converter cells includes adjusting the reference value if the number Y decreases.
